(19) United States
(12) Patent Application Publication
(10) Pub. No.: US 2003/0224806 A1
(43) Pub. Date: Dec. 4, 2003

(54) System and method for network data quality measurement

(76) Inventor: Igal Hebron, Parkland, FL (US)

Correspondence Address: PERKINS COIE LLP/AWS, P.O. BOX 1247, SEATTLE, WA, 98111-1247, US

(21) Appl. No.: 10/334,451

(22) Filed: Dec. 31, 2002

Related U.S. Application Data
(60) Provisional application No. 60/385,766, filed on Jun. 3, 2002.

(51) Int. Cl. H04Q 7/20

(52) U.S. Cl. 455/457; 455/226.2

(57) ABSTRACT

A system and method for measuring signal data quality of one or more areas served by a wireless communication network is disclosed herein. A wireless communication device communicates with the wireless network and receives signal quality measurements. A location system provides geographic location information corresponding to where each of the signal quality measurements is obtained. The signal quality measurements and geographic location information can be stored at a device located at the drive test vehicle, and can be presented in a graphical format for easy viewing and interpretation.

### CROSS-REFERENCE TO RELATED APPLICATIONS

The present application claims the benefit of U.S. Provisional Application No. 60/385,766 filed Jun. 3, 2002, and which is incorporated herein it its entirety.

The present application is related to U.S. application Ser. No. 10/090,265 (Attorney Docket No. 101948041US1) entitled “Real-Time Network Analysis and Performance Management” by Charles S. Zappala, filed Mar. 4, 2002 and commonly assigned to AT&T Wireless Services, Inc.

### BACKGROUND

Voice and/or data devices operating with a wireless communication network experience variation in performance. For example, a cellular phone user may experience very good call quality or less than satisfactory call quality depending upon location and/or the time of day. Entities that design, construct, and/or maintain wireless communication networks are very motivated to provide the best service all of the time to as many users as possible. Unfortunately this can be difficult due to limited resources and the inherently dynamic nature of the services being provided. For example, there are a finite number of physical network components, such as base stations and repeaters, in the wireless communication network. The locations of the physical network components are also fixed and constrained by factors such as geography and governmental regulations. The assignment of network parameters, such as power of individual network components and frequencies assigned to geographical areas, are interrelated to each other and among the physical network components. Moreover, use of the network varies over time as the number of users, location of the users, movement of the users, services accessed by the users, and/or the users themselves change.

Network performance data are typically collected and analyzed to optimize network configurations. The data collection may occur periodically or on an as-needed basis, such as when additional physical network components are added to the network. The data collection may also occur for the entire geographic area covered by the network or a portion of the geographic area covered by the network. Data collection methods include drive testing or switch statistical analysis.

In drive testing, a vehicle having a network performance measurement tool or equipment is driven through an area of interest to obtain network performance data. Drive testing provides real-time data representative of what a device user's experience may be like. Unfortunately, among others, such performance measurement equipment is quite expensive, not adaptive for testing different or future wireless networks, and may not accurately simulate actual user devices. Other problems may exist, which are not enumerated herein.

### BRIEF DESCRIPTION OF THE DRAWINGS

FIG. 1 is a block diagram of one embodiment of a network data quality measurement system.

FIG. 2 is a detailed block diagram of one embodiment of a computing device included in the system of FIG. 1.

FIG. 3 is a flow diagram of one embodiment of the implementation of a signal quality measurement tool included in the device of FIG. 2.

FIG. 4 is a screen shot illustrating one embodiment of a graphical user interface (GUI) provided by the device in FIG. 2.

FIG. 5 is a screen shot illustrating another embodiment of a GUI provided by the device in FIG. 2.

FIG. 6 is a screen shot illustrating information provided on the GUI of FIG. 4.

FIG. 7 is an illustration of a graphical representation of the data collected in a drive test using the system of FIG. 1.

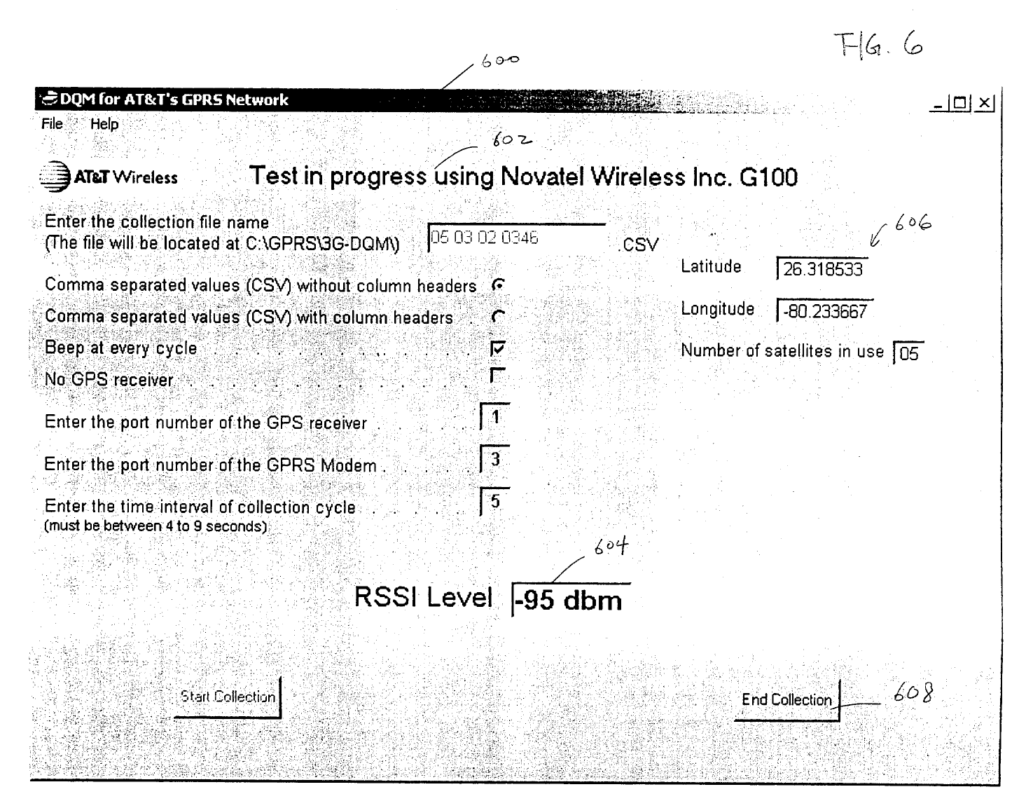

In the drawings, identical reference numbers identify identical or substantially similar elements or acts. To easily identify the discussion of any particular element or act, the most significant digit or digits in a reference number refer to the figure number in which that element is first introduced (e.g., element 604 is first introduced and discussed with respect to FIG. 6).

The headings provided herein are for convenience only and do not necessarily affect the scope or meaning of the claimed invention.

### DETAILED DESCRIPTION

Described in detail below is a system and method for obtaining performance data relating to a wireless communication network. In one embodiment, drive testing of an area of interest served by the wireless communication network is performed with a network data quality measurement tool. The measurement tool can be implemented with a general-purpose computer (such as a laptop computer), a wireless modem, and a location identifier (such as a GPS receiver). The measurement tool is inexpensive, adaptive to different wireless devices and wireless communication networks, provides user interface features for collecting the performance data, and provides real-time and graphical representation of the performance data. These are other benefits are provided by embodiments of the present invention.

The following description provides details for a thorough understanding of, and enabling description for, embodiments of the invention. However, one skilled in the art will understand that the invention may be practiced without these details. In other instances, well-known structures and functions are not shown or described in detail to avoid unnecessarily obscuring the description of embodiments of the invention.

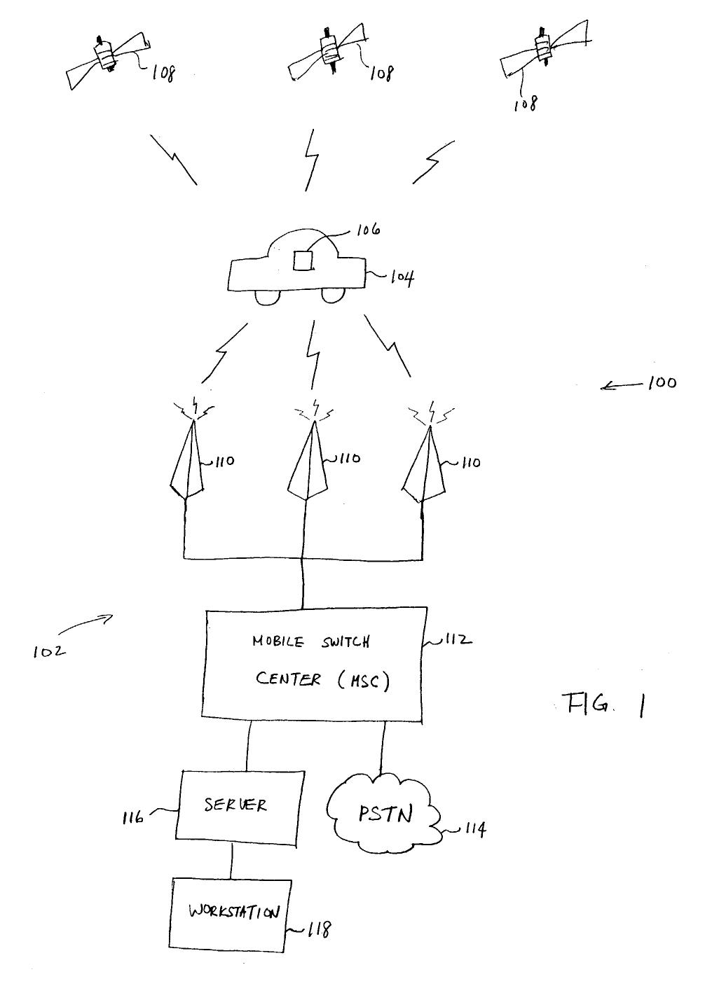

Referring to FIG. 1, one embodiment of a network data quality measurement system 100 is shown. The system includes a wireless service provider equipment 102, a vehicle 101 with a computing device 106, and a plurality of global positioning system (GPS) satellites 108.

The provider equipment 102 includes equipment and applications typically provided and maintained by a wireless service provider. The provider equipment 102 is one example of an arrangement of elements, but other are possible. The provider equipment 102 includes a plurality of base stations 110 (also referred to as cell sites) coupled to a mobile switch center (MSC) 112 (also referred to as a switch). The MSC 112 is coupled to each of a public switch telephone network (PSTN) 114 and a server 116. The server 116 is coupled to a workstation 118.

The base stations 110 are located at different locations within a wireless network and can be in wireless communication with wireless communication devices (not shown) or the computer device 106. The MSC 112 and the server 116 are configured to provide data or signal processing, routing and storage. Although a single MSC and a single server are shown, more them one MSC and/or server are possible depending on geographic distribution, processing capacity, and/or storage capacity. The MSC 112 and the server 116 are configured to include billing/account information associated with wireless communication devices, mobile identification numbers (MINs), electronic serial numbers (ESNs), information relating to control channels and traffic channels, etc.

The workstation 118 is configured to access information available on the provider equipment 102. As an example, data being acquired on the computing device 106 may also be available in real-time on the workstation 118. Alternatively, the server 116 may be coupled to the Internet and the workstation 118 couples to the serve 116 via the Internet. The PSTN 114 is configured to process calls to a land line telephone network system.

The GPS satellites 108 are configured to send timing and distance signals (collectively, the GPS signals) to a GPS receiver included in a receiving device. In FIG. 1, three GPS satellites are shown, but more than these GPS satellites, such as eight satellites, may be implemented. The GPS signals are used to calculate the location of the receiving device (e.g., longitude and latitude coordinates).

The vehicle 104 may be a variety of vehicles suitable for conducting a drive test. The computing device 106 is transported by the vehicle 104 during the drive test. To be discussed in detail below, the computing device 106 communicates with the GPS satellites 108 and one or more of the base stations 110. The computing device 106 receives GPS signals from the GPS satellites 108, and detects and/or handles signals from one or more of the base stations 110.

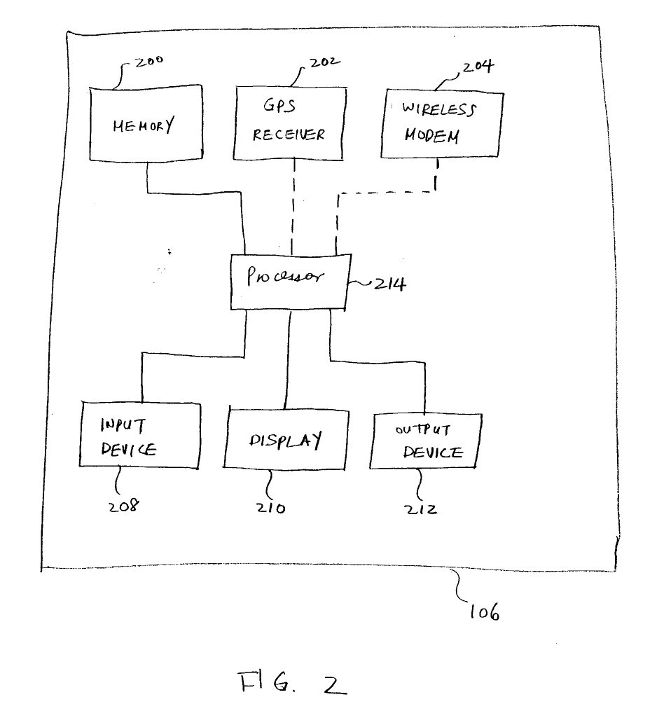

One embodiment of a detailed block diagram of the computing device 106 is shown in FIG. 2. Each of a memory 200, a GPS receiver 202, a wireless modem 204, an input device 208, a display 210, and an output device 212 is coupled to a processor 214. The memory 200, also referred to as a data storage, is configured to be any type of computer-readable media that can store data, such as a magnetic hand and floppy disk drives, optical disk drives, magnetic cassettes, tap drives, flash memory cards, digital video disks (DVD), Bernoulli cartridges, RAMs, ROMs, smart cards, etc. Indeed, any medium for storing or transmitting computer-readable instructions and data may be employed.

The GPS receiver 202 is configured to receive GPS signals from the GPS satellites 108. The GPS receiver 202 may include hardware, firmware, and/or software to derive an absolute location of the computer device 106. The GPS receiver 202 receives the GPS signals or coordinates as a National Marine Electronics Association (NMEA) string and then converts the GPS coordinates into latitude, longitude, and velocity numbers. Alternatively, the conversion of the received GPS coordinates may be performed at the processor 214, the GPS receiver 202 may be removable from the computing device 106, or the GPS receiver 202 and the wireless modem 204 may be one device. As an example, the GPS receiver 202 may be a GARMIN GPS 35 TracPak, which is a removable GPS device with a USB connector.

The wireless modem 204 is configured to transmit and receive wireless signals with the base stations 110. The wireless modem 204 can be a modem compatible with GSM, CDMA, TDMA, GPRS, EDGE, UMTS, or other future networks. Examples of the wireless modem 204 include the Motorola Time Port, Novatel PCMCIA G100, the PCMCIA AirCard 710 from Sierra Wireless, and the AirLink modem with built-in GPS receiver. The wireless modem 204 is removable from the computing device 106 such that signal quality measurements with different wireless modems can be obtained.

The input device 208 is configured to permit a user to interface with the computing device 106. One or more of the input device 208 may be provided, and can include a keyboard and a pointing device such as a mouse. The display 210 is configured to present information for view by the user. The display 210 may be a variety of display devices such as a liquid crystal display (LCD), cathode ray tube (CRT) display, flat panel display, etc. One or more of the output device 212 may be included in the computing device 106.

The output device 212 can be a display, printer, plotter, speakers, storage, a connection to a network, etc. The output device 212 may be removable and/or optional. The processor 214 may be a microprocessor, microcontroller, or other processing device.

The computer device 106 may be a general purpose computer that is GPS enabled and capable of communicating with the provider equipment 102. In one embodiment, the computing device 106 is a portable computer such as a laptop computer. Aspects of the invention can be implemented in any suitable computing environment. Although not required, aspects and embodiments of the invention will be described in general context of computer-executable instructions, such as routines executed by a general purpose computer (e.g., a server or personal computer). Those skilled in the art will appreciate that aspects of the invention can be practiced with other computer system configurations, including Internet appliances, hand-held devices, wearable computers, cellular or mobile phones, multi-processor systems, microprocessor-based or programmable consumer electronics, get-top boxes, network PCs, mini-computers, mainframe computers and the like. Aspects of the invention can be embodied in a special purpose computer or data processor that is specifically programmed, configured or constructed to perform one or more of the computer-executable instructions explained herein. Indeed, the term “computer,” as used generally herein, refers to any of the above devices as well as to any data processor.

Aspects of the invention can also be practiced in distributed computing environments where tasks or modules are performed by remote processing devices and which are linked through a communications network, such as a local area network (LAN), a wide area network (WAN), or the Internet. In a distributed computing environment, program modules or sub-routines may be located in both local and remote memory storage devices. Aspects of the invention described below may be stored or distributed on computer-readable media, including magnetic and optically readable and removable computer disks stored as firmware in chips (e.g., EEPROM chips), as well as distributed electronically over the Internet or other networks (including wireless networks). Those skilled in the relevant art will recognize that portion of the invention may reside on a server computer, while corresponding portions reside on a client computer. Data structures and transmission of data particular to aspects of the invention are also encompassed within the scope of the invention.

In one embodiment, a signal or data quality measurement (DQM) tool is included in the computing device 106. The DQM tool is configured to facilitate wireless signal quality measurements regarding a wireless network, such as the network associated with the provider equipment 102. The DQM tool may be, for example, included in the memory 200 and is software or code in Visual Basic language. The DQM tool is implemented in a drive test within at least a portion of the area served by the wireless network using the vehicle 104.

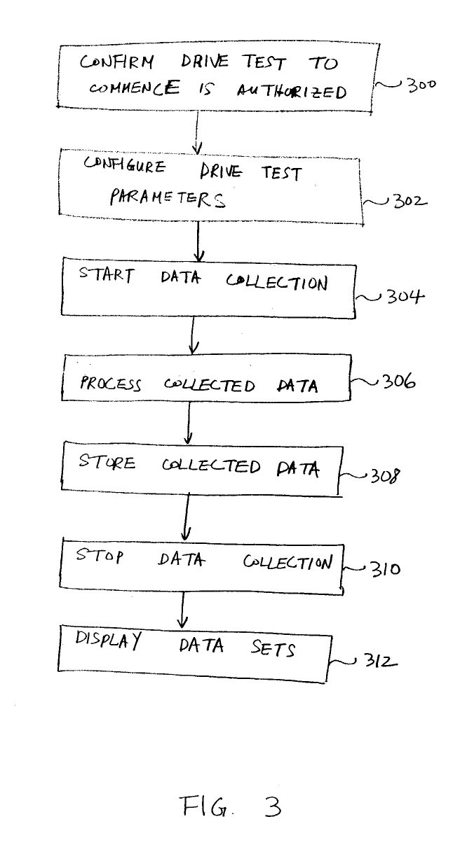

Referring to FIG. 3, one embodiment of a flow diagram illustrating the implementation of the DQM tool is shown. In order to investigate a customer complaint or issue about the wireless network, maintain sufficient signal quality within the wireless network, or to demonstrate to a potential customer (e.g., corporate client) the signal quality provided by the wireless network, a drive test using the DQM tool may occur. One person may operate the vehicle 104 and also implement the DQM tool to collect the signal quality data.

At a block 300, a security check is performed to confirm that the drive test that will commence is authorized. The security check looks to see whether an authorized person or device is accessing the provider equipment 102 and/or the DQM tool. Accordingly, the computing device 106 may require a user login or password information to access the DQM tool or to communicate with the provider equipment 102. The computing device 106 may alternatively have a device identifier such that the DQM tool confirm that it is being implemented on an authorized device (e.g., a computer owned by the wireless service provider). The computing device 106, and in particular the wireless modem 204, may alternatively include a unique identifier number that is recognized by the provider equipment 102. In any case, if the proper authorization does not exist, the DQM tool is configured to terminate and cannot be subsequently accessed. Such security feature insures that the DQM tool is not copied and/or being used by a computing wireless service provider or persons (e.g., systems or RF engineers employed by the wireless service provider associated with the provider equipment 102) other than those with the need to do so.

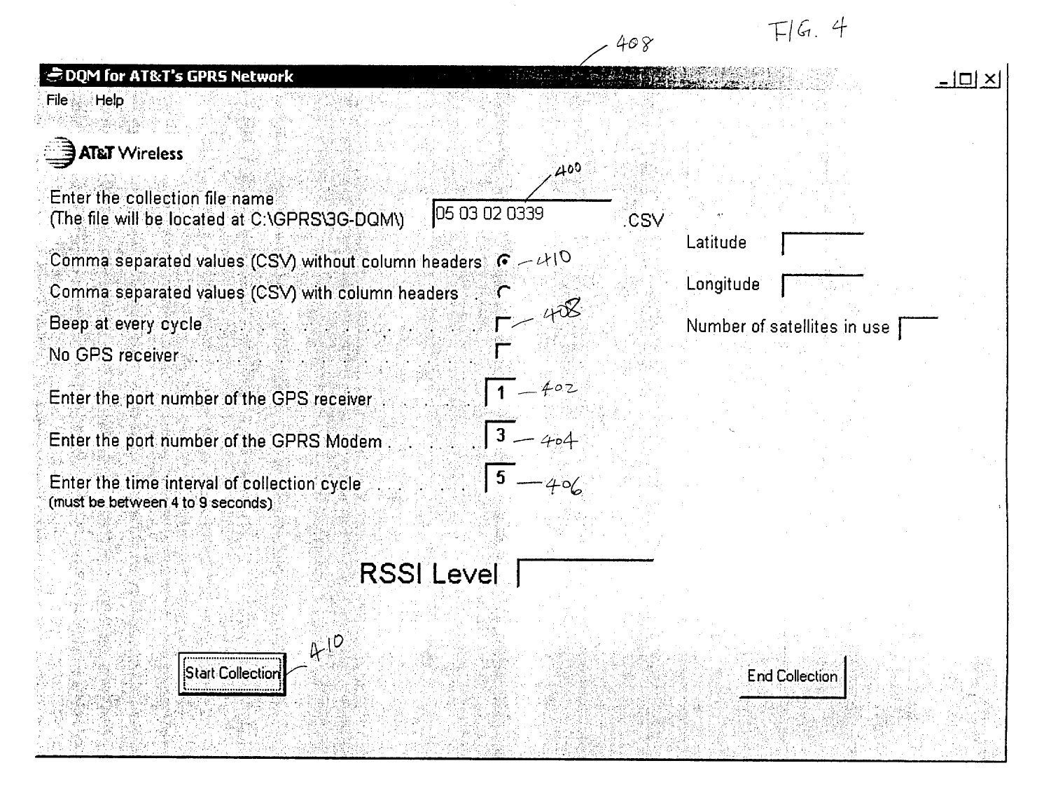

Once authorization has been confirmed, the drive test parameters are configured at a block 302. A variety of drive test parameters exist, as shown in FIG. 4, such as the test path to be driven (e.g., the route that the vehicle 104 will travel in the drive test), selecting and connecting the wireless device to be tested against the wireless network (e.g., the wireless modem 204), a data file name 400 that the collected data is to be saved under, a port number 402 of the GPS receiver 202, a port number 404 of the wireless modem 204, and a time interval 406 between successive data collection points. A graphical user interface (GUI) 408 is provided by the DQM tool and is displayed, for example, on the display 210 for the authorized user to specify the parameters or fields 400-406. The computing device 106 may automatically provide parameters 402, 404 when the wireless modem 204 and the GPS receiver 202 are connected therein. Similarly, parameters 400 or 406 may also be automatically provided.

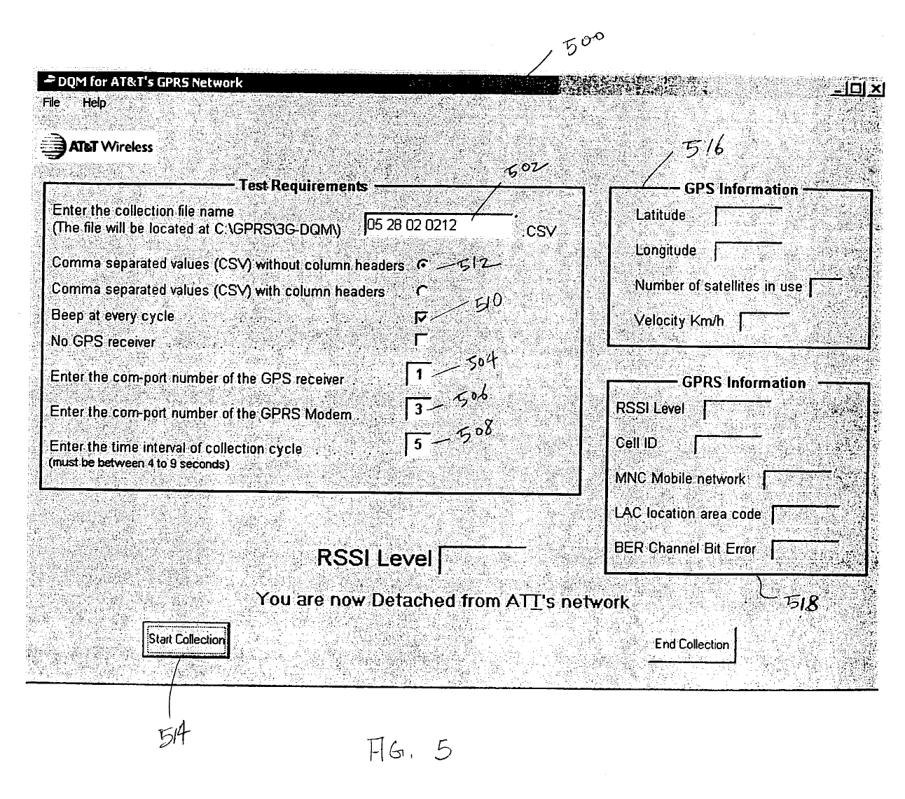

In FIG. 5, an alternate GUI is shown. In a GUI 500, fields for a data file name 502, a port number of the GPS receiver 504, a port number of the wireless modem 506, a time interval between successive date collection points 508, a second indication 510, and a format of the stored data 512 are included. (Similarly, the GUI 408 also includes fields for a sound indication 408 and a data format 410.)

Activation of checking of the sound indication fields 408, 510 provides one or more audio sounds during the drive test. These sounds are indicative of conditions or events relating to the signal quality or interaction with the provider equipment 102. Such sounds notify the person inside the vehicle 104 of conditions or change in condition in real-time without viewing the display 210. This feature is especially useful when one person is driving and collecting the signal data, since he can keep his eyes on the road and still be kept informed of at least some of the data being collected.

As an example, four different audio sounds (e.g., beeps) can be provided. A first sound can be a “healthy” beep that beeps every 5 seconds (or collection cycle) during the drive test as long as the signal strength received by the wireless modem 204 is above −95 dbm. A second sound can be an “unhealthy” beep that beeps every 5 seconds when the signal strength is below −95 dbm. A third sound can be a different beep whenever a handoff to a difficult base station occurs. A fourth sound can be still another different beep whenever the wireless modem 204 loses connection with the wireless network and data collection cannot continue.

Once the data collection parameters are set, data collection can commence by clicking on a start collection icon, such as a start collection icon 410 or 514 included in the GUI 408 or 500, respectively, in a block 304. In response, the DQM tool accesses the wireless modem 204 and sends AT commands for the wireless modem to communicate with the provider equipment 102 (e.g., one of the base stations 110) and retrieve information regarding signal quality. Information regarding signal quality may include signal strength, channel number, received signal strength indication (RSSI), block error rate, bit error rate (BER), cell ID, location area code (LAC), velocity, round trip ping, etc.

The DQM tool also opens a second communication port to the GPS receiver 202. The GPS coordinates received as a NMEA string are converted (using formulas or algorithms) into latitude, longitude, and velocity numbers (block 306). Signal quality information received from the wireless modem 204 may also be processed (e.g., normalized, filtered, etc.) at the block 306.

A data set comprising signal quality information and latitude, longitude, and velocity numbers for each specified time interval or cycle are thus obtained by the DQM tool. The data sets can be provided to the user in real-time as the drive test is in progress. In FIG. 6, a GUI 600 (similar to the GUI 408) is provided at the display 210 during the data collection phase. The GUI 600 includes a title 602 indicating that a drive test is in progress and identifies the wireless modem 204 being tested (e.g., information such as the brand, model, and/or type of device). The GUI 600 also includes a signal strength field 604 to display the current received RSSI level, and location fields 606 to display the current location at which the RSSI level of the field 604 was obtained (e.g., a latitude, longitude, and number of GPS satellites used to obtain the GPS coordinates). Alternatively, a GUI such as that shown in FIG. 5 may be provided during the data collection phase, and provide location fields 516 (e.g., latitude, longitude, number of GPS satellites in use, and velocity) and wireless network information fields 518 (e.g., RSSI level, cell or base station identification, MNC mobile network identification, location area code, and channel BER).

At a block 308, each data set collected during the drive test is stored in the memory 200. In one embodiment, the data sets are formatted into a comma-separated value (CSV) file format and stored as a CSV file in a hard drive included in the memory 200. Each data set can include several fields of data such as latitude, longitude, velocity, time, date, cell or base station name, call identification number, sector identification number, channel, RSSI level, BER, and other signal quality values, location information, or wireless network information. It should be understood that a variety of data file formats are possible, as long as such formats are compatible with a graphical display of the data sets as discussed below. When enough data has been collected, clicking on an end collection icon 608 stops the data collection process.

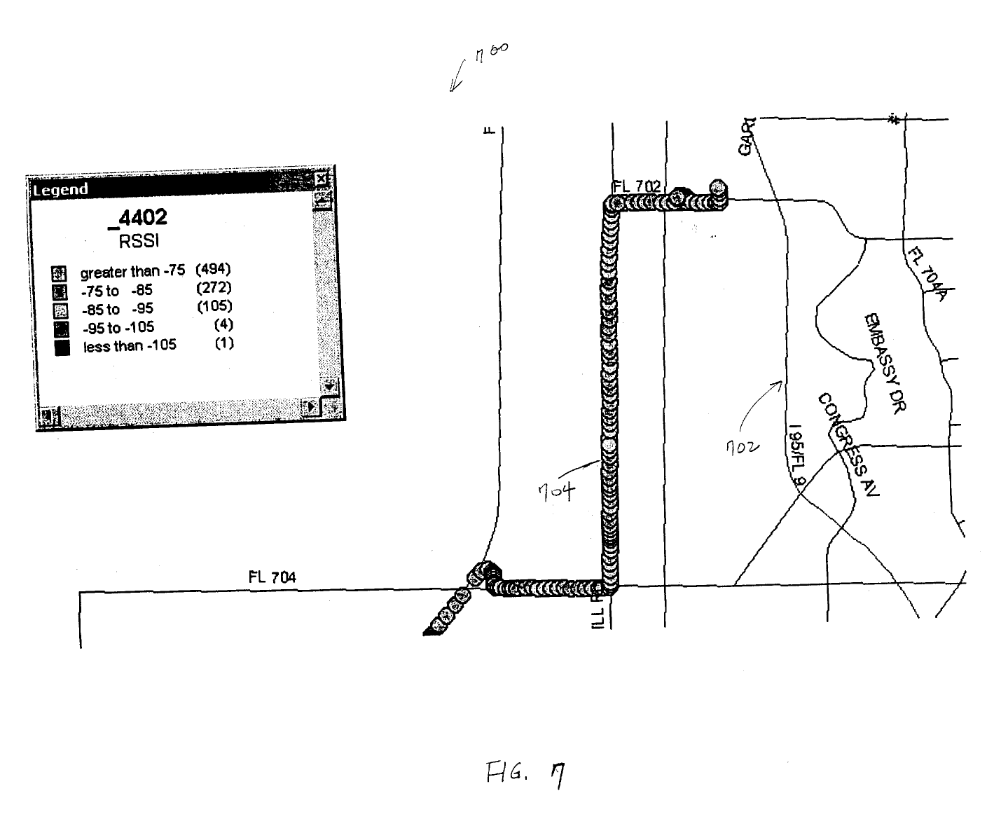

At a block 312, the data sets associated with a drive test can be graphically represented at a display, such as the display 210 or the workstation 118, or provided on paper. The CSV file saved at the memory 200 is processed by (e.g., imported into) a graphics or mapping application or sub-routine (e.g., MapInfo manufactured by MapInfo Corporation of Troy, N.Y.) to show the signal quality at every collection cycle overlaid on the route traveled during the drive test. For example, FIG. 7 illustrates a signal quality map 700 generated using MapInfo. The map 700 includes streets 702 and signal quality indications 704 corresponding to points along the streets where signal data was collected. The graphical representation permits persons to easily review and analyze the collected data. The graphical representation can be invoked in real-time as the data collection is in progress or after data collection has been completed. The graphical representation can be viewed on the computing device 106 or on a different device.

Various alternate embodiments are possible. For example, the collected data may also be transmitted (either using the wireless network or via a different network) to a remote location so that the drive test can be viewed by a person remote from the vehicle 104 in real-time. The remote location may be a remote server or a workstation such as the workstation 118. This remote transmission feature permits real-time changes to the drive test to obtain the most relevant signal data. For example, if during a drive test, the originally planned route is not providing the desired signal data, then the person at the vehicle 104 can contact an RF engineer to review the data obtained in the drive test in real time. In response, the RF engineer can provide a different route or make changes to the provider equipment 102 on the fly (e.g., power management for cell coverage, handoffs etc.). These changes can then be tested in real-time. Such interactivity would save time, money, and effort, rather than returning to the office with the collected data, determining the problem, and then conducting another drive test to try out the “solution” to the problem.

As another example, wireless communication devices other than wireless modems may also be checked against the wireless network. Cellular phones may be coupled to the computing device via a connector or adapter and its performance or reception with the provider equipment 102 can be checked. In another example, the DQM tool may be configured to perform a roundtrip ping test, in which a check is performed to see whether a response is returned from the server. In some instances, there may be good signal quality but nevertheless a user device may be unable to communicate within the network due to problems associated with the landline connecting to the substation, to the backbone of the network, or other reasons.

In another embodiment, a revised or scaled-down version of the DQM tool may be provided to a customer (e.g., a business or company) so that he may perform a drive test. The data collected from this drive test may be accessed by the service provider (e.g., a system engineer employed by the service provider) for analysis. Providing the customer with the ability to perform a drive test may be beneficial when, for example, the customer may be complaining of poor coverage or performance, or the service provider is unable to confirm the poor performance noted by the customer.

In this manner, a system and method for measuring signal data quality of areas served by a wireless communication network is disclosed herein. The DQM tool is inexpensive, flexible, and can be implemented without a specialized or dedicated hardware/firmware device. The DQM tool may be configured for use with more than one type of wireless communication network and for future networks. The DQM tool may also be configured to study the performance of a variety of wireless communication devices. The DQM tool permits a variety of data collection parameters to be selected and provides indications of data quality in real-time.

Thus, not only does the DQM tool check a given wireless network, it can also check a variety of wireless devices against the network. This flexibility allows an RF engineer to conduct the drive test with the same type or model of wireless modem as used by actual customers, rather than a fixed high quality wireless modem that may not be affordable or available to actual customers. Since wireless network technology also changes quickly, it is beneficial to have a measurement tool that is updateable as the technology changes.

Although not required, aspects of the invention have been described in the general context of computer-executable instructions, such as routines executed by a general purpose computer, e.g., a server, wireless device or personal computer. Those skilled in the relevant art will appreciate that the invention can be practiced with other communications, data processing or computer system configurations, including Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers and the like. Indeed, the term “computer”, as used generally herein, refers to any of the above devices and systems, as well as any data processor. Aspects of the invention can be embodied in a special purpose computer or data processor that is specifically programmed, configured or constructed to perform one or more of the computer-executable instructions explained in detail herein. Aspects of the invention can also be practiced in distributed computing environments where tasks or modules are performed by remote processing devices, which are linked through a communications network. In a distributed computing environment, program modules may be located in both local and remote memory storage devices.

Aspects of the invention described herein may be stored or distributed on computer-readable media, including magnetic and optically readable and removable computer discs, as well as distributed electronically over the Internet or over other networks (including wireless networks). Those skilled in the relevant art will recognize that portions of the invention reside on a server computer, while corresponding portions reside on a client computer such as a mobile device. Data structures and transmission of data particular to aspects of the invention are also encompassed within the scope of the invention.

Unless the context clearly requires otherwise, throughout the description and the claims, the words “comprise,” “comprising” and the like are to be construed in an inclusive sense as opposed to an exclusive or exhaustive sense; that is tot say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portion of this application. When the claims use the word “or” in reference to a list of two or more items, that word covers all of the following interpretations of the word: any of the items in the list, all of the items in the list, and any combination of the items in the list.

The above description of illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize.

All of the above U.S. patents and applications and other references are incorporated herein by reference. Aspects of the invention can be modified, if necessary, to employ the systems, functions and concepts of the various references described above to provide yet further embodiments of the invention.

These and other changes can be made to the invention in light of the above detailed description. In general, in the following claims, the terms used should not be construed to limit the invention to the specific embodiments disclosed in the specification and the claims, but should be construed to include all networked digital messaging systems that operate under the claims. Accordingly, the invention is not limited by the disclosure, but instead the scope of the invention is to be determined entirely by the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

I claim:

1. A method for analyzing performance of a wireless communication network, the method comprising:
selecting the wireless communication network from at least two different wireless communication networks;
selecting a wireless communication device from at least two different wireless communication devices;
setting data collection parameters associated with particular signal quality data to be obtained from the wireless communication device coupled to a measurement device;
receiving signal quality data and location data at different points within a geographic area served by the wireless communication network at the measurement device;
processing at least the location data; and
graphically representing the received signal quality data and the processed location data.

2. The method of claim 1, further comprising:
moving the wireless communication device and the measurement device within the geographic area served by the wireless communication network via a vehicle;
communicating with the wireless communication network to receive the signal quality data and global positioning system (GPS) satellites to receive the location data; and
providing audio sounds indicative of signal quality or interaction with the wireless communication network before graphically representing the received signal quality data and the process location data.

3. The method of claim 1, further comprising:
checking security for accessing the measurement device and receiving signal quality data and location data;
transmitting the received signal quality data and the location data to a remote location from the measurement device; and
potentially modifying the geographic area to be analyzed or parameters associated with the wireless communication network in response to analysis of the transmitted data at the remote location.

4. A method for analyzing performance of a wireless communication network, the method comprising:
selecting a wireless communication device from at least two different wireless communication devices, wherein the wireless communication devices differ by manufacturer, model, or wireless network compatibility;
communicating with the wireless communication network to obtain signal quality data between the wireless communication device and the wireless communication network;
communicating with a location identification system to obtain location data corresponding to geographic locations at which the signal quality data area are obtained; and
providing the signal quality data and the location data in a format accessible for analysis.

5. The method of claim 4, wherein the location identification system includes at least three global positioning system (GPS) satellites and a GPS receiver.

6. The method of claim 4, wherein providing the signal quality data and the location data includes mapping a geographic area where the signal quality data was obtained and overlaying the signal quality data over the corresponding mapped geographic area.

7. The method of claim 4, further comprising:
processing the location data to obtain latitude and longitude coordinates; and
storing the latitude and longitude coordinates in a CSV file format.

8. The method of claim 4, further comprising:
moving the wireless communication device coupled to a measurement device using a vehicle.

9. The method of claim 4, further comprising:
setting data collection parameters associated with the signal quality data and the location data to be obtained; and
confirming authorization to obtain the signal quality data and the location data before communicating with the wireless communication network to obtain signal quality data.

10. The method of claim 4, wherein the signal quality data includes at least one of signal strength, channel number, received signal strength indication (RSSI) level, block error rate, and bit error rate (BER).

11. The method of claim 4, further comprising:
saving the signal quality data and the location data in a CSV file format at a measurement device coupled to the wireless communication device.

12. The method of claim 4, wherein the wireless communication device is at least one of a wireless modem, a personal digital assistant (PDA) with wireless capability, and a cellular telephone that is compatible with at least one of a GSM network, a GPRS network, an EDGE network, a UMTS network, and future networks.

13. The method of claim 4, wherein the wireless communication network is at least one of a GSM network, a GPRS network, an EDGE network, a UMTS network, and future networks.

14. The method of claim 4, further comprising:
transmitting the obtained signal quality data and the location data to a location remote from where the data was obtained; and
potentially modifying the geographic locations or parameters associated with the wireless communication network in response to analysis of the transmitted data at the remote location while the data collection is in progress.

15. The method of claim 4, further comprising:
providing a first sound indicative of the signal quality data being of acceptable signal quality;
providing a second sound indicative of the signal quality data being of unacceptable signal quality;
providing a third sound indicative of no signal data; and
providing a fourth sound indicative of a handoff to a different base station of the wireless communication network, wherein the first, second, third, and fourth sounds are different from each other.

16. An apparatus for measuring signal quality of a wireless communication network, the apparatus comprising:
means for identifying a location;
means for wirelessly communicating with the wireless communication network;
means for setting data collection parameters;
means for processing the collected data;
means for presenting the collected data into a format accessible for analysis; and
means for handling more than one means for wirelessly communicating.

17. The apparatus of claim 16, wherein the means for identifying a location comprises a GPS receiver.

18. The apparatus of claim 16, wherein the means for wirelessly communicating comprises at least one of a wireless modem, a personal digital assistant (PDA) with wireless capability, and a cellular telephone that is compatible with at least one of a GSM network, a GPRS network, an EDGE network, a UMTS network, and future networks.

19. The apparatus of claim 16, wherein the wireless communication network comprises at least one of a GSM network, a GPRS network, an EDGE network, a UMTS network, and future networks.

20. The apparatus of claim 16, wherein the means for presenting the collected data comprises a map of a route traversed during the data collection and the signal quality data in relative intensity.

21. The apparatus of claim 16, wherein the means for handling comprises a port for removing the means for wirelessly communicating and replacing with an another means for wirelessly communicating.

22. The apparatus of claim 16, wherein the apparatus comprises a general-purpose computer that is GPS enabled, includes a wireless modem compatible with the wireless communication network, and a signal quality measurement application.

23. The apparatus of claim 16, wherein the means for setting data collection parameters comprises a user interface displayed before the data collection commences.

24. The apparatus of claim 16, wherein the means for identifying a location and the means for wirelessly communicating comprises a GPS enabled wireless modem.

25. A computer-readable medium having instructions stored thereon, the instructions executable by a processor to cause the processor to:
accept data collection parameters associated with a signal measurement and a location information to be obtained in a drive test; and
in response to the accepted data collection parameters,
cause a wireless communication device to communicate with a wireless communication network to obtain the signal measurement,
cause a location system to obtain the location information, and
provide an audio or visual indication of the quality of the signal measurement in real-time, wherein the data collection parameters are configured to accept more than one type of the wireless communication device to be tested.

26. The computer-readable medium of claim 25, wherein responding to the accepted collection parameters comprises:
accessing a mapping application or subroutine to graphically present the location information and the signal measurement.

27. The computer-readable medium of claim 25, wherein accepting the data collection parameters comprises:
providing a graphical user interface before data collection commences, wherein the data collection parameters is selected from a group including a data collection file name, a file format, an audio indication, a port location of a GPS receiver, a port location of the wireless communication device, and a data collection interval time.

28. The computer-readable medium of claim 25, wherein the computer-readable medium is microcode included in a computer located at a moving vehicle.

29. The computer-readable medium of claim 25, wherein the computer-readable medium is a memory included in a computer located at a moving vehicle.

30. A computer-readable medium storing a display description for providing collected data associated with a wireless communication device in communication with a wireless communication network for a signal quality measurement, comprising:
a first portion identifying whether the signal quality measurement is in progress;
a second portion providing the signal quality measurement in real-time for each collection cycle; and
a third portion providing location information substantially in real-time, the location information corresponding to the geographic location at which the signal quality measurement provided in the second portion was obtained, wherein the wireless communication device may be a wireless communication device from more than one manufacturer, model, or wireless network compatibility.

31. The computer-readable medium of claim 30, further comprising:
a fourth portion identifying the wireless communication device,
a fifth portion selectable by an authorized user to specify data collection parameters;
a sixth portion selectable by the authorized user to start and end data collection; and
a seven portion providing a graphical representation of the signal quality measurement and the corresponding location information.

32. The computer-readable medium of claim 31, wherein at least one of the first, second, third, fourth, fifth, sixth, and seventh portions is accessible by a person located remote from the computer-readable medium in real-time.

33. A signal quality measurement device for analyzing performance of a wireless communication network, the signal quality measurement device comprising:
a wireless modem being removable from the signal quality measurement device;
a geographic location receiver;
a measurement application configured to provide a user interface for setting data collection parameters associated with signal quality of the wireless communication network at the wireless modem at a certain geographic location, coordinate activities of the wireless modem and the GPS receiver, and provide indication of the data being collected in real-time; and
a mapping application configured to graphically present the collected data.

34. The signal quality measurement device of claim 33, further comprising:
a memory for storing the collected data, wherein the collected data is stored in a CSV file format, the measurement application and the mapping application can be a single application, and the wireless modem and the GPS receiver can be a single device.
